(19) United States
(12) Patent Application Publication
(10) Pub. No.: US 2011/0148832 A1
(43) Pub. Date: Jun. 23, 2011

(54) TRANSFLECTIVE DISPLAY

(75) Inventors: Xiangyi Nie, Foster City, CA (US); Tetsuya Okuda, Foster City, CA (US)

(73) Assignee: SONY ERICSSON MOBILE COMMUNICATIONS AB, Lund (SE)

(21) Appl. No.: 12/644,590

(22) Filed: Dec. 22, 2009

(51) Int. Cl. G06F 3/038; G09G 5/02

(52) U.S. Cl. 345/207; 345/694; 345/88; 345/92; 345/102

(57) ABSTRACT

A device includes a light source and a display that includes a number of pixels. Each of the pixels includes a red subpixel, a blue subpixel, a green subpixel and a reflective subpixel. The device also include control logic configured to activate the reflective subpixels in the display when the light source is turned off.

### TECHNICAL FIELD OF THE INVENTION

The invention relates generally to displays and, more particularly, to transflective displays.

### DESCRIPTION OF RELATED ART

A transflective liquid crystal display (LCD) operates in two modes. A first mode is a transmissive mode which is ideal for low or normal ambient light conditions. In the transmissive mode, light from a white light source located on the backside of the LCD is directed via a light guide through the various LCD layers. A second mode is a reflective mode, which is ideal for high ambient light conditions. In the reflective mode, ambient light entering the front side of the LCD traverses one or more LCD layers and then is reflected back by a reflector positioned between the LCD and the light guide on the LCD's backside.

Conventional transflective LCDs typically use a dual cellgap pixel design. In such a design, each subpixel (e.g., red, green or blue subpixel) has a transmissive region and a reflective region. One drawback with such LCDs is that the reflectance associated with the reflective mode is usually low since the ambient light passes through color filters of the LCD two times, thereby causing a significant percentage of light (e.g., 90%) to be absorbed by the color filters. As a result, most transflective LCDs are only barely visible even in bright environments.

### SUMMARY

According to one aspect, a device is provided. The device includes at least one light source, a display and control logic. The display comprises a plurality of pixels, each of the pixels including a red subpixel, a blue subpixel, a green subpixel and a reflective subpixel. The control logic is configured to activate the reflective subpixels in the display when the at least one light source is turned off.

Additionally, the device may further comprise a sensor configured to detect a brightness of at least a portion of the pixels, wherein when activating the reflective subpixels, the control logic may be configured to drive the reflective pixels to be on when the detected brightness of the portion of pixels is less than a threshold.

Additionally, when detecting a brightness of at least a portion of the pixels, the sensor may be configured to detect brightness values of each of the red, green and blue subpixels associated with individual pixels in the portion of the pixels. The control logic may also be configured to add the brightness values to generate an overall brightness value for each of the individual pixels.

Additionally, the control logic may be further configured to drive the reflective subpixels to be off when the at least one light source is turned on.

Additionally, the plurality of pixels may comprise an array of subpixels and wherein each reflective subpixel is located adjacent a red subpixel, a green subpixel and a blue subpixel.

Additionally, the plurality of pixels may comprise an array of subpixels, wherein each reflective subpixel is located in a column of reflective subpixels.

Additionally, the device may further comprise a plurality of thin-film transistors (TFTs), each of the TFTs being associated with a subpixel, and wherein the control logic may be configured to drive TFTs associated with the reflective subpixels to turn on the reflective subpixels when the device is in a reflective mode.

Additionally, the device may further comprise at least one sensor configured to detect ambient light conditions. The control logic may also be configured to receive ambient light information from the at least one sensor, set the device to a transmissive mode when the ambient light information is less than a threshold, set the device to a reflective mode when the ambient light information is greater than the threshold, and automatically activate or de-activate the reflective subpixels based on whether the device is in the transmissive mode or the reflective mode.

Additionally, the control logic may be further configured to automatically activate and deactivate the reflective subpixels based on ambient light conditions or input provided by a user of the device.

Additionally, the device may comprise a mobile terminal or a portable computer.

According to another aspect, a method is provided in a device that includes a display. The method comprises detecting ambient lighting conditions. The method also includes activating reflective subpixels associated with each pixel in the display when the ambient lighting conditions indicate that an external light level is greater than a threshold.

Additionally, the method may further comprise detecting a brightness of at least a portion of the pixels, wherein activating reflective subpixels comprises driving the reflective pixels to be on when the detected brightness is less than a first value.

Additionally, detecting a brightness of at least a portion of the pixels may comprise detecting brightness values associated with red, green and blue subpixels comprising a pixel in the portion of pixels. The method may further comprise adding the brightness values to generate an overall brightness value, and determining whether the brightness value is greater than the first value.

Additionally, the method may further comprise automatically activating and deactivating the reflective subpixels based on the ambient lighting conditions.

Additionally, the method may further comprise receiving input from a user, the input corresponding to setting a transmissive mode or a reflective mode associated with the display, and turning on or off reflective subpixels in the display based on the user input.

According to a further aspect, a device that includes at least one backlight, a liquid crystal display and control logic may be provided. The liquid crystal display may comprise a plurality of pixels, each of the pixels including a red subpixel, a blue subpixel, a green subpixel and a reflective subpixel. The control logic may be configured to activate the reflective subpixels in the display when the backlight is off.

Additionally, the device may further comprise a sensor configured to detect a luma or brightness level of at least a portion of the pixels, and when activating the reflective subpixels, the control logic may be configured to drive the reflective pixels to be on when the detected luma or brightness level associated with the portion of pixels is less than a threshold.

Additionally, the control logic may be configured to add luma levels for each of the red, green and blue subpixels associated with a first pixel, and activate a reflective subpixel associated with the first pixel when the sum of the luma levels is less than the threshold.

Additionally, the control logic may be further configured to deactivate the reflective subpixels when the at least one backlight is on.

Additionally, the control logic may be configured to automatically activate and deactivate the reflective subpixels based on ambient light conditions.

### BRIEF DESCRIPTION OF THE DRAWINGS

Reference is made to the attached drawings, wherein elements having the same reference number designation may represent like elements throughout.

FIG. 1 is a diagram of an exemplary device in which methods and systems described herein may be implemented;

FIG. 2 is a functional block diagram of exemplary components implemented in the device of FIG. 1;

FIG. 3 is a block diagram of components implemented in the device of FIG. 2 according to an exemplary implementation;

FIG. 4 is a block diagram illustrating portions of the display of FIG. 1 according to an exemplary implementation;

FIG. 5 is a diagram illustrating a portion of the display of FIG. 4 according to an exemplary implementation;

FIG. 6 is a flow diagram illustrating exemplary processing associated with the user device of FIG. 1; and

FIG. 7 is a diagram illustrating a portion of the display of FIG. 4 in another configuration.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and their equivalents.

### Exemplary System

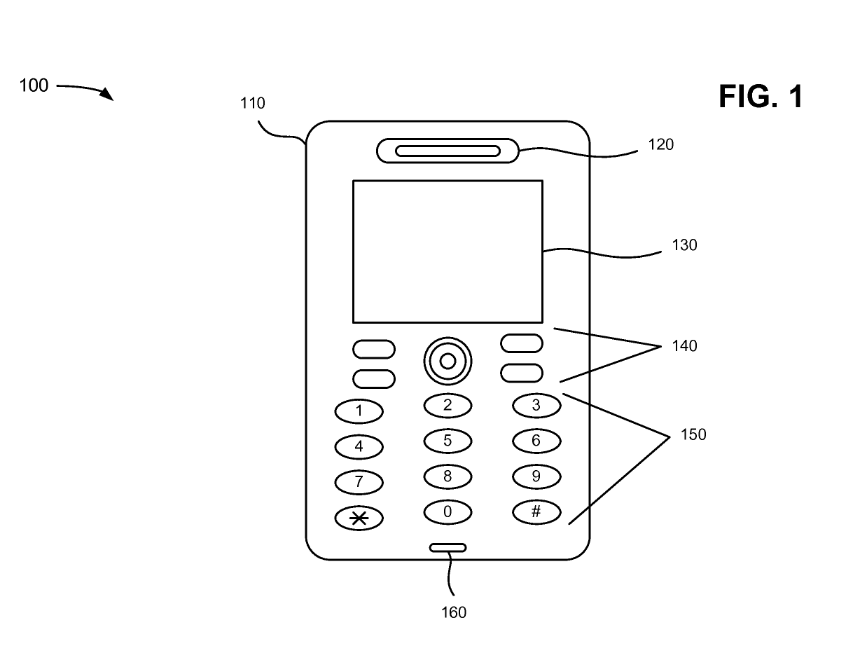

FIG. 1 is a diagram of an exemplary user device 100 in which methods and systems described herein may be implemented. In an exemplary implementation, user device 100 may be a mobile terminal. As used herein, the term “mobile terminal” may include a cellular radiotelephone with or without a multi-line display; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices. It should also be understood that systems and methods described herein may also be implemented in other devices that display information of interest and allow users to interact with the displayed information with or without various other communication functionality. For example, user device 100 may include a personal computer (PC), a laptop computer, a personal digital assistant (PDA), a media playing device (e.g., an MPEG audio layer 3 (MP3) player, a video game playing device), a global positioning system (GPS) device, etc., that may not include various communication functionality for communicating with other devices.

Referring to FIG. 1, user device 100 may include a housing 110, a speaker 120, a display 130, control buttons 140, a keypad 150, and a microphone 160. Housing 110 may protect the components of user device 100 from outside elements. Speaker 120 may provide audible information to a user of user device 100.

Display 130 may provide visual information to the user. For example, display 130 may provide information regarding incoming or outgoing telephone calls and/or incoming or outgoing electronic mail (e-mail), instant messages, short message service (SMS) messages, etc. Display 130 may also display information regarding various applications, such as a phone book/contact list stored in user device 100, the current time, video games being played by a user, downloaded content (e.g., news or other information), etc.

In an exemplary implementation, display 130 may be a transflective LCD that operates in a reflective mode during high ambient light conditions (e.g., outdoors) and a transmissive mode during low ambient light conditions (e.g., indoors). During the reflective mode, dedicated subpixels may allow ambient or external light to be reflected back and illuminate display 130. The reflective subpixels may be turned off during the transmissive mode so that the reflective subpixels do not adversely impact color saturation. The reflective/transmissive quality of display 130 may be automatically adjusted or switched based on the particular environment in which user device 100 is operating, as described in detail below. This may allow display 130 to be easily viewable in various light conditions without increasing power requirements associated with illuminating (e.g., backlighting) display 130.

Control buttons 140 may permit the user to interact with user device 100 to cause user device 100 to perform one or more operations, such as place a telephone call, play various media, etc. In an exemplary implementation, control buttons 140 may include one or more buttons that control various applications associated with display 130.

For example, control buttons 140 may include a dial button, hang up button, play button, etc. In an exemplary implementation, control buttons 140 may include one or more buttons that control various illumination settings associated with display 130. For example, one of control buttons 140 may be used to toggle between a reflective mode and transmissive mode associated with display 130, as described in detail below. Further, one of control buttons 140 may be a menu button that permits the user to view various settings associated with user device 100. Using the menu, a user may also be able to toggle user device 100 between a reflective mode and a transmissive mode, as described in detail below.

Keypad 150 may include a standard telephone keypad. Microphone 160 may receive audible information from the user. In some implementations, the audible information may be used for activating applications or routines stored within user device 100.

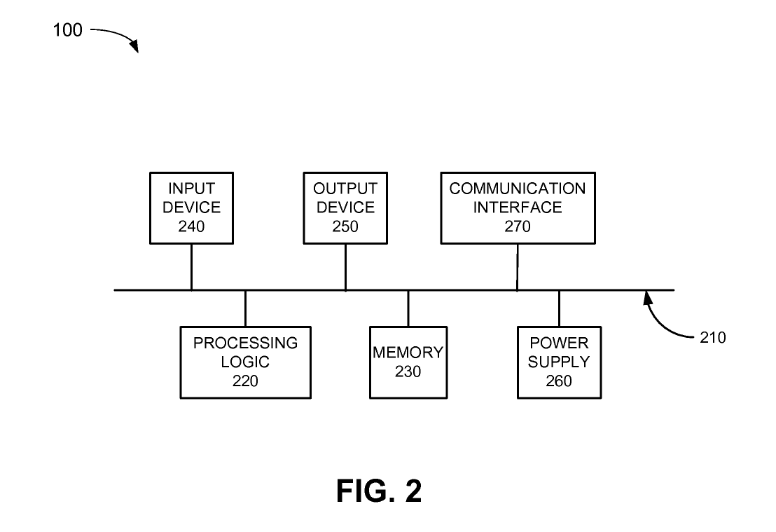

FIG. 2 is a diagram illustrating components of user device 100 according to an exemplary implementation. User device 100 may include a bus 210, processing logic 220, a memory 230, an input device 240, an output device 250, a power supply 260 and a communication interface 270. One skilled in the art would recognize that user device 100 may be configured in a number of other ways and may include other or different elements. For example, user device 100 may include one or more modulators, demodulators, encoders, decoders, etc., for processing data.

Bus 210 permits communication among the components of user device 100. Processing logic 220 may include a processor, microprocessor, an application specific integrated circuit (ASIC), field programmable gate array (FPGA) or other processing logic. Processing logic 220 may execute software instructions/programs or data structures to control operation of user device 100.

Memory 230 may include a random access memory (RAM) or another type of dynamic storage device that stores information and instructions for execution by processing logic 220; a read only memory (ROM) or another type of static storage device that stores static information and instructions for use by processing logic 220; a flash memory (e.g., an electrically erasable programmable read only memory (EEPROM)) device for storing information and instructions; and/or some other type of magnetic or optical recording medium and its corresponding drive. Memory 230 may also be used to store temporary variables or other intermediate information during execution of instructions by processing logic 220. Instructions used by processing logic 220 may also, or alternatively, be stored in another type of computer-readable medium accessible by processing logic 220. A computer-readable medium may include one or more memory devices.

Input device 240 may include mechanisms that permit an operator to input information to user device 100, such as microphone 160, keypad 150, control buttons 140, a keyboard (e.g., a QWERTY keyboard, a Dvorak keyboard, etc.), a gesture-based device, an optical character recognition (OCR) based device, a joystick, a touch-based device, a virtual keyboard, a speech-to-text engine, a mouse, a pen, voice recognition and/or biometric mechanisms, etc. In an exemplary implementation, display 130 may be a touch screen display that acts as an input device.

Output device 250 may include one or more mechanisms that output information to the user, including a display, such as display 130, a printer, one or more speakers, such as speaker 120, etc. As described above, in an exemplary implementation, display 130 may be a touch screen display. In such an implementation, display 130 may function as both an input device and an output device.

Power supply 260 may include one or more batteries or other power source components used to supply power to components of user device 100. Power supply 260 may also include control logic to control application of power from power supply 260 to one or more components of user device 100.

Communication interface 270 may include any transceiver that enables user device 100 to communicate with other devices and/or systems. For example, communication interface 270 may include a modem or an Ethernet interface to a LAN. Communication interface 270 may also include mechanisms for communicating via a network, such as a wireless network. For example, communication interface 270 may include one or more radio frequency (RF) transmitters, receivers and/or transceivers and one or more antennas for transmitting and receiving RF data via a network.

User device 100 may provide a platform for a user to send and receive communications (e.g., telephone calls, electronic mail, text messages, multi-media messages, short message service (SMS) messages, etc.), play music, search the Internet, or perform various other functions. User device 100 may also perform processing associated with controlling the reflectivity associated with components of display 130. User device 100 may perform these operations in response to processing logic 220 executing sequences of instructions contained in a computer-readable medium, such as memory 230. Such instructions may be read into memory 230 from another computer-readable medium via, for example, and communication interface 270. In alternative embodiments, hard-wired circuitry may be used in place of or in combination with software instructions to implement processes consistent with the invention. Thus, implementations described herein are not limited to any specific combination of hardware circuitry and software.

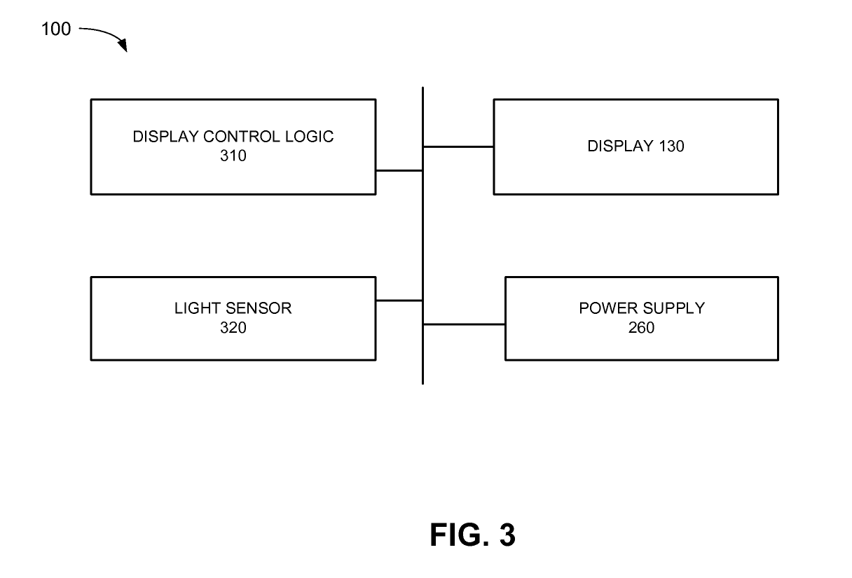

FIG. 3 is an exemplary block diagram of components implemented in user device 100. Referring to FIG. 3, user device 100 may include display control logic 310, light sensor 320, display 130 and power supply 260. Display control logic 310 may be included in processing logic 220 and light sensor 320 may be included in input device 240.

Display control logic 310 may control whether display 130 is in a transmissive mode or a reflective mode based on, for example, the particular environment in which user device 100 is operating. In an exemplary implementation, display control logic 310 may receive information from sensor 320 identifying operating conditions associated with display 130.

Light sensor 320 may include one or more sensors that identify the ambient lighting conditions under which user device 100 is operating. For example, light sensor 320 may receive ambient light and generate a signal representing the ambient light condition. Display control logic 310 may use this information to determine whether user device 100 is to be placed in a transmissive mode (e.g., backlight on) or a reflective mode. Light sensor 320 may continuously or periodically monitor the ambient light level and automatically provide this signal/information to display control logic 310.

Light sensor 320 may also include one or more sensors that sense and/or measure the overall luma or brightness of each pixel of display 130 and provide this information to display control logic 310. Light sensor 320 may continuously or periodically monitor the luma or brightness level of each pixel and automatically provide this signal/information to display control logic 310. Display control logic 310 may then determine whether to turn on/off reflective subpixels.

For example, in one implementation, display control logic 310 may detect that the overall brightness of red, green and blue subpixels that make up the pixels in display 130. When the overall brightness (e.g., combined brightness of the red, green and blue sub-pixels) is below a threshold, this indicates that backlight in user device 100 is turned off. This may correspond to a condition when ambient light conditions are high. In such as case, display control logic 310 may automatically turn reflective subpixels to an “on” state to allow reflected light to be used to illuminate display 130.

As described above, in other implementations, a user may adjust a mode associated with the reflective/transmissive quality of display 130 using a control button or switch or set a mode associated with the reflective/transmissive quality of display 130 via a menu displayed to the user of user device 100. In each case, display control logic 310 may independently drive various subpixels, such as reflective subpixels, based on the operating mode of user device 100, as described in detail below.

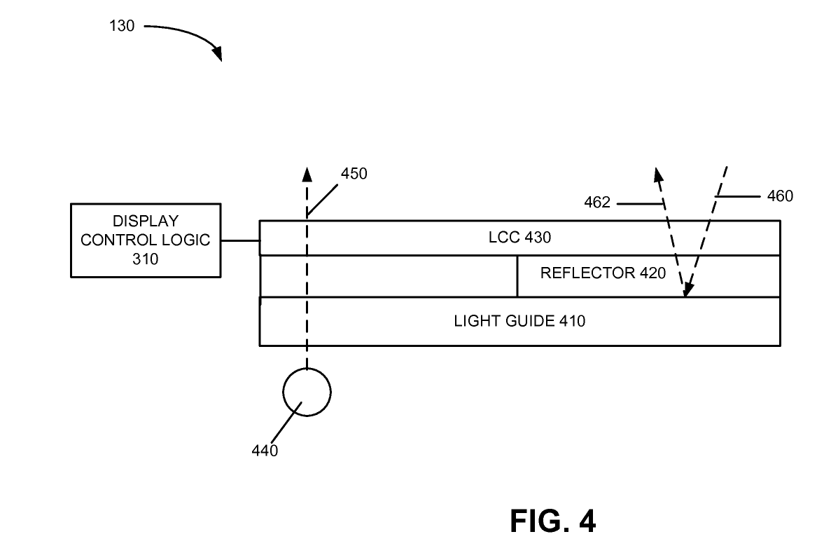

FIG. 4 schematically illustrates portions of display 130 according to an exemplary implementation. Referring to FIG. 4, display 130, also referred to herein as liquid crystal display (LCD) 130, may include light guide 410, reflector 420, liquid crystal cell (LCC) 430 and light source 440. It should be understood that LCD 130 may include other devices/components (e.g., a polarizer, a glass substrate, an array of thin-film transistors, etc.) that are not shown in FIG. 4 for simplicity.

Light guide 410 may be a conventional light guide that directs light from a light source, such as light source 440, up through liquid crystal cell 430 and other layers of display 130. Reflector 420 may represent one or more films, layers or components (e.g., a bumpy reflector) that reflect ambient light back up through the liquid crystals in liquid crystal cell 430. Reflector 420 is illustrated as being located on one side of display 130 for simplicity. In each case, reflector 420 may be situated to reflect ambient light when user device 100 is in a reflective mode, but not impede light from light source 440 when user device 100 is in a transmissive mode. In addition, reflector 420 is shown as being a separate component from LCC 430. However, in some implementations, reflector 420 may be considered to be part of LCC 430.

LCC 430 may be part of a LCD (e.g., LCD 130) that includes one or more polarizing films, one or more glass substrates, a color filter, liquid crystals, or other components used to display information to a user via display 130. In an exemplary implementation, LCC 430 may include an array of thin-film transistors (TFTs) associated with pixels of LCC 430. For example, each pixel of LCC 430 may have one or more TFTs associated with that pixel that may be activated based on what is being displayed on LCD 130. Each pixel may be associated with a particular color or may be a monochrome pixel. For example, in an exemplary implementation, each pixel of LCC 430 may include red, green and blue subpixels, as well as a reflective subpixel that may be monochrome.

Light source 440 may be a conventional light source, such as a light emitting diode (LED), a fluorescent light source, incandescent light source, etc. Only one light source 440 is shown for simplicity. It should be understood that light source 440 may include a number of individual light sources, such as a number of LEDs. During low or normal level light conditions, light from light source 440 may be directed through light guide 410 and may pass through LCC 430, as illustrated by dashed line 450 in FIG. 4. During high level light conditions, ambient light incident on an exposed surface of LCC 430 may pass through LCC 430 and substantially reflect off reflector 420 and back through LCC 430, as indicated by dashed lines 460 and 462 in FIG. 4, to at least partially illuminate display 130, as described in detail below.

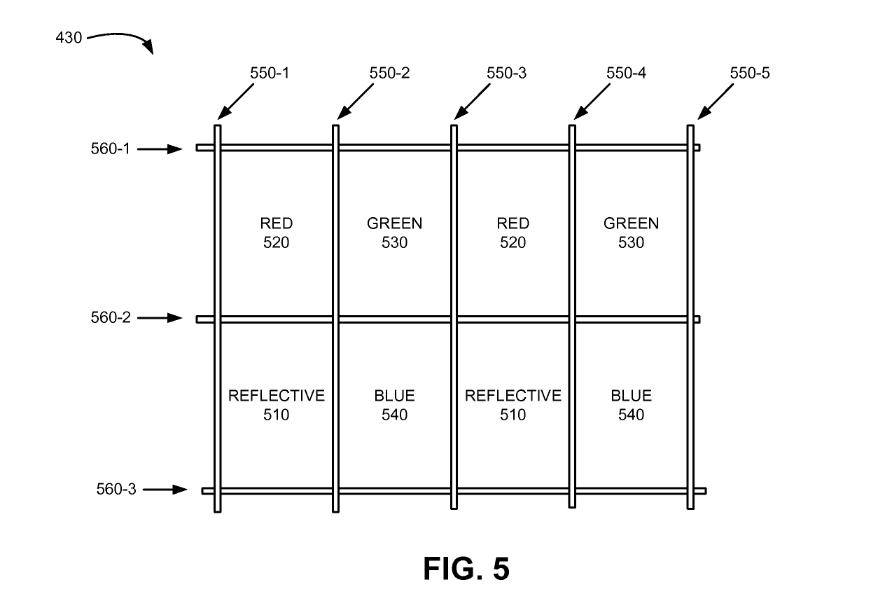

FIG. 5 illustrates a portion of LCC 430 consistent with an exemplary implementation. Referring to FIG. 5, LCC 430 may include a number of reflective subpixels 510, along with a number of red subpixels 520, green subpixels 530 and blue subpixels 540. FIG. 5 illustrates two pixels of display 130, with each pixel including a reflective subpixel 510, a red subpixel 520, a green subpixel 530 and a blue subpixel 540. LCC 430 may also include data lines 550-1 through 550-5 (also referred to as column lines) and gate lines 560-1 through 560-3 (also referred to as row lines).

In an exemplary implementation, display control logic 310 (FIG. 3) may drive various transistors included in a TFT array (not shown) to put reflective subpixels 510 in an on/off state based on particular mode in which display 130 is operating. For example, each reflective subpixel 510 may be independently driven using a TFT to be “on” when user device 100 is in a reflective mode. As described above, in an exemplary implementation, the reflectance may be dependent on the overall brightness (e.g., luma) of the corresponding pixel (e.g., combination of the luma for the red, green and blue subpixels). Display control logic 310 may drive the reflective subpixels 510 to be on/off using data lines 550 and gate lines 560.

For example, during the transmissive mode, display control logic 310 may drive the TFTs associated with reflective subpixels 510 to be off. In this case, reflective subpixels 510 will be dark/black and will not affect the color saturation of display 130. During the reflective mode, however, display control logic 310 may turn off the red, green and blue subpixels 520-540 and turn on reflective subpixels 510. In such cases, only the reflective subpixels 510 are on and the reflectance may be high since the reflected ambient light (illustrated by arrows 460 and 462 in FIG. 4) will not pass through any color filters. That is, no color filter material will be located over reflective pixels 510, resulting in a very high portion of the ambient light being reflected through the upper surface of display 130 to provide good illumination of display 130.

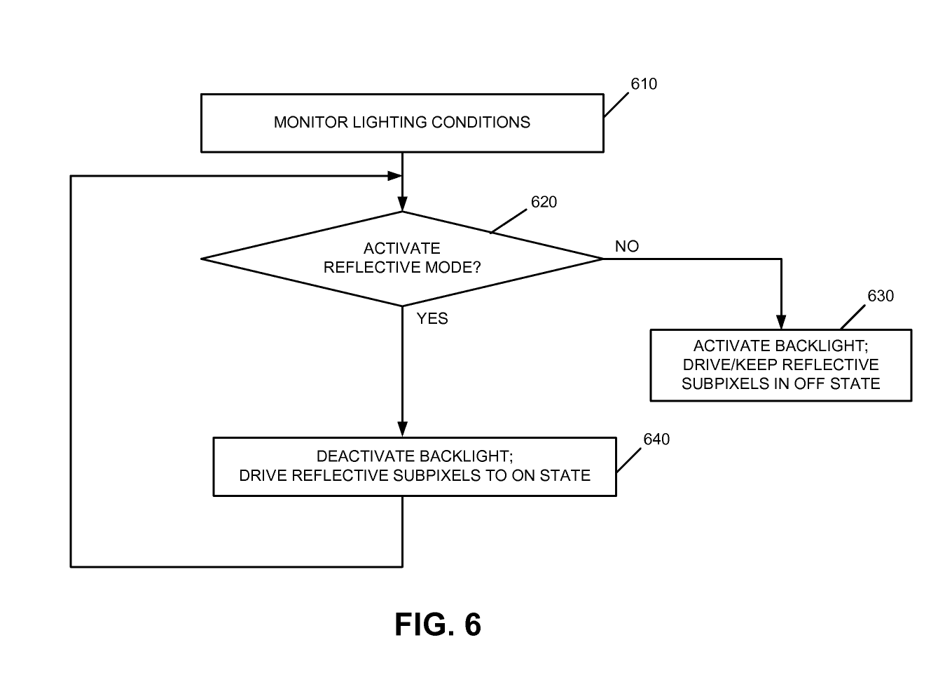

FIG. 6 is a flow diagram illustrating processing by user device 100 in an exemplary implementation. Processing may begin when user device 100 powers up. Light sensor 320 may automatically monitor the ambient lighting conditions in the environment in which user device 100 is operating (act 610). Light sensor 320 may also forward information representing the ambient lighting conditions to display control logic 310.

Display control logic 310 may determine if the ambient lighting conditions are greater than a predetermined lighting threshold and whether user device 100 should be placed in a reflective mode (act 620). For example, the lighting threshold may represent a level in which normal backlighting of display 130 is used to allow a user to easily view display 130. In this example, assume that user device 100 is being used indoors in a relatively dark environment and that the lighting information provided from light sensor 320 to display control logic 310 indicates that the lighting level is below the predetermined threshold. In this case, display control logic 310 may determine that user device 100 should be in a transmissive mode (act 620—no). Display control logic 310 may activate or turn on light source 440 (act 630).

As described above, in an exemplary implementation, light sensor 320 may continuously or periodically monitor the luma or brightness level of each subpixel (e.g., red, green and blue subpixels 520-540) and automatically provide this signal/information to display control logic 310. When user device 100 is in the transmissive mode, the corresponding luma of the red, green and blue subpixels 520-540 may be high and display control logic 310 may determine that the brightness of each pixel is adequate for viewing purposes. In this case, display control logic 310 may drive/keep reflective subpixels 510 in the off state (act 630). In the off state, reflective subpixels 510 will be dark/black and will not adversely impact color saturation of display 130. That is, no reflected ambient light will impact colors provided via the red, green and blue subpixels 520-540. In some instances, if display control logic 310 determined that the brightness of each pixel was less than adequate, display control logic 310 may activate the reflective subpixels 510 to enhance the brightness of display 130.

If, however, the ambient lighting conditions are greater than the threshold value and user device 100 determines that reflective mode should be activated (act 620—yes), display control logic 310 may turn off light source 440 (act 640). Display control logic 310 may also activate reflective subpixels 510 (act 640). For example, display control logic 310 may use TFTs to drive the appropriate data lines 550 and gate lines 560 to turn on reflective subpixels 510. In the on state, reflective subpixels 510 allow substantially all the light the ambient light to be reflected via reflective subpixels 510 since no color filter is located over the reflective subpixels 510. Therefore, in this implementation, during the reflective mode, display 130 functions as a monochrome display since no color filtering is applied to the reflected light.

In this manner, display control logic 310 turns on/off reflective subpixels 510 based on the operating mode of use device 100. As a result, the reflected ambient light provides adequate light to illuminate display 130 when user device 100 is in the reflective mode and turns off reflective subpixels 510 when user device 100 is in the transmissive mode to avoid reducing color saturation of display 130.

User device 100 may then continue to operate with reflective subpixels 510 turned on/off until a change in ambient lighting conditions occurs. That is, display control logic 310 may continue to monitor lighting conditions and switch user device 100 from the reflective mode to the transmissive mode or vice versa based on the lighting conditions.

In some implementations, display control logic 310 may not automatically cut power from light source 440 when user device 100 in the reflective mode. That is, both the transmissive subpixels (e.g., red, green and blue subpixels 520-540) and reflective subpixels 510 may be on simultaneously. In such scenarios, color saturation may not be as great as when user device 100 is in the transmissive mode. However, the overall brightness of display 130 may be improved.

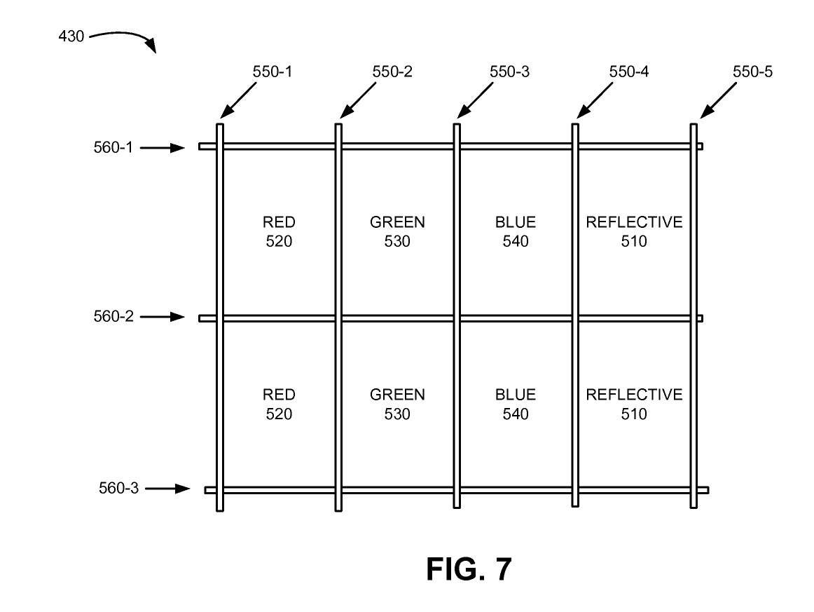

In addition, in the exemplary implementation described above with respect to FIG. 5, reflective subpixels 510 were illustrated as being located in particular locations with respect to LCC 430. In other implementations, LCC 430 may be arranged differently. For example, FIG. 7 illustrates an alternative subpixel arrangement associated with LCC 430. Referring to FIG. 7, LCC 430 may include red subpixels 520, green subpixels 530, blue subpixels 540 and reflective subpixels 510 configured in columns. In this implementation, driving signals from display control logic 310 to the TFTs associated with the subpixels 510-540 may be simplified. That is, a single signal may be used to drive an entire column of reflective subpixels 510. In each case, reflective subpixels 510 may be activated when user device 100 is in the reflective mode and de-activated when user device 100 is in the transmissive mode.

### CONCLUSION

Implementations described herein provide a display in which the transmissive/reflective quality or state of one or more components associated with the display can be automatically adjusted based on the particular environment. By including dedicated reflective subpixels, the display may be easily viewable in any lighting conditions. In addition, switching from the transmissive mode to the reflective mode may save power associated with powering the display.

The foregoing description of the embodiments described herein provides illustration and description, but is not intended to be exhaustive or to limit the invention to the precise form disclosed. Modifications and variations are possible in light of the above teachings or may be acquired from the practice of the invention.

For example, aspects have been described above with respect to detecting a luma or brightness value of each pixel prior to activating a reflective subpixel. In other implementations, display control logic 310 may activate/deactivate the reflective subpixels based on the operation mode (e.g., transmissive or reflective) without measuring the brightness of the associated color pixels). That is, reflective subpixels 510 may be activated in the reflective mode and de-activated in the transmissive mode.

Further, while series of acts have been described with respect to FIG. 5, the order of the acts may be varied in other implementations consistent with the invention. Moreover, non-dependent acts may be performed in parallel.

It will also be apparent to one of ordinary skill in the art that aspects of the invention, as described above, may be implemented in computer devices, cellular communication devices/systems, media playing devices, methods, and/or computer program products. Accordingly, aspects of the present invention may be embodied in hardware and/or in software (including firmware, resident software, micro-code, etc.). Furthermore, aspects of the invention may take the form of a computer program product on a computer-usable or computer-readable storage medium having computer-usable or computer-readable program code embodied in the medium for use by or in connection with an instruction execution system. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as a processor, a microprocessor, an ASIC, an FPGA or other processing logic, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Further, the phrase “based on,” as used herein is intended to mean “based, at least in part, on” unless explicitly stated otherwise.

The scope of the invention is defined by the claims and their equivalents.

What is claimed is:

1. A device, comprising:
at least one light source;
a display comprising a plurality of pixels, each of the pixels including a red subpixel, a blue subpixel, a green subpixel and a reflective subpixel; and
control logic configured to:
activate the reflective subpixels in the display when the at least one light source is turned off.

2. The device of claim 1, further comprising:
a sensor configured to detect a brightness of at least a portion of the pixels, wherein when activating the reflective subpixels, the control logic is configured to:
drive the reflective pixels to be on when the detected brightness of the portion of pixels is less than a threshold.

3. The device of claim 2, wherein when detecting a brightness of at least a portion of the pixels, the sensor is configured to detect brightness values of each of the red, green and blue subpixels associated with individual pixels in the portion of the pixels, and
the control logic is configured to add the brightness values to generate an overall brightness value for each of the individual pixels.

4. The device of claim 1, wherein the control logic is further configured to drive the reflective subpixels to be off when the at least one light source is turned on.

5. The device of claim 1, wherein the plurality of pixels comprise an array of subpixels and wherein each reflective subpixel is located adjacent a red subpixel, a green subpixel and a blue subpixel.

6. The device of claim 1, wherein the plurality of pixels comprise an array of subpixels and wherein each reflective subpixel is located in a column of reflective subpixels.

7. The device of claim 1, further comprising:
a plurality of thin-film transistors (TFTs), each of the TFTs being associated with a subpixel, wherein the control logic is configured to:
drive TFTs associated with the reflective subpixels to turn on the reflective subpixels when the device is in a reflective mode.

8. The device of claim 1, further comprising:
at least one sensor configured to detect ambient light conditions, and wherein the control logic is configured to:
receive ambient light information from the at least one sensor,
set the device to a transmissive mode when the ambient light information is less than a threshold,
set the device to a reflective mode when the ambient light information is greater than the threshold, and
automatically activate or de-activate the reflective subpixels based on whether the device is in the transmissive mode or the reflective mode.

9. The device of claim 1, wherein the control logic is further configured to:
automatically activate and deactivate the reflective subpixels based on ambient light conditions or input provided by a user of the device.

10. The device of claim 1, wherein the device comprises a mobile terminal or a portable computer.

11. In a device comprising a display, a method comprising:
detecting ambient lighting conditions; and
activating reflective subpixels associated with each pixel in the display when the ambient lighting conditions indicate that an external light level is greater than a threshold.

12. The method of claim 11, further comprising:
detecting a brightness of at least a portion of the pixels, wherein activating reflective subpixels comprises:
driving the reflective pixels to be on when the detected brightness is less than a first value.

13. The method of claim 12, wherein the detecting a brightness of at least a portion of the pixels comprises:
detecting brightness values associated with red, green and blue subpixels comprising a pixel in the portion of pixels, the method further comprising:
adding the brightness values to generate an overall brightness value; and
determining whether the brightness value is greater than the first value.

14. The method of claim 11, further comprising:
automatically activating and deactivating the reflective subpixels based on the ambient lighting conditions.

15. The method of claim 11, further comprising:
receiving input from a user, the input corresponding to setting a transmissive mode or a reflective mode associated with the display; and
turning on or off reflective subpixels in the display based on the user input.

16. A device, comprising:
at least one backlight;
a liquid crystal display comprising a plurality of pixels, each of the pixels including a red subpixel, a blue subpixel, a green subpixel and a reflective subpixel; and
control logic configured to:
activate the reflective subpixels in the display when the backlight is off.

17. The device of claim 16, further comprising:
a sensor configured to detect a luma or brightness level of at least a portion of the pixels, wherein when activating the reflective subpixels, the control logic is configured to:
drive the reflective pixels to be on when the detected luma or brightness level associated with the portion of pixels is less than a threshold.

18. The device of claim 17, wherein the control logic is configured to add luma levels for each of the red, green and blue subpixels associated with a first pixel, and
activate a reflective subpixel associated with the first pixel when the sum of the luma levels is less than the threshold.

19. The device of claim 16, wherein the control logic is further configured to deactivate the reflective subpixels when the at least one backlight is on.

20. The device of claim 16, wherein the control logic is further configured to:
automatically activate and deactivate the reflective subpixels based on ambient light conditions.
